(19) United States
(12) Patent Application Publication
(10) Pub. No.: US 2013/0326454 A1
(43) Pub. Date: Dec. 5, 2013

(54) APPARATUS AND METHOD FOR REDUCING PEAK POWER USING ASYNCHRONOUS CIRCUIT DESIGN TECHNOLOGY

(71) Applicant: Electronics and Telecommunications Research Institute, (US)

(72) Inventors: Sung-Nam KIM, Daejeon (KR); Chi-Hoon SHIN, Daejeon (KR); Sung-Gun SONG, Gwangju (KR); Seong-Woon KIM, Gyeryong-si (KR)

(21) Appl. No.: 13/835,875

(22) Filed: Mar. 15, 2013

(30) Foreign Application Priority Data
May 31, 2012 (KR) 10-2012-0058247

(51) Int. Cl. G06F 17/50

(52) U.S. Cl. CPC G06F 17/5072
USPC 716/120

(57) ABSTRACT

Disclosed herein are an apparatus and method for reducing peak power using an asynchronous circuit design technology. The apparatus includes a combinational circuit unit and an asynchronous control circuit unit. The combinational circuit unit divides a combinational circuit into a plurality of partial circuits based on the depth of input and output. The asynchronous control circuit unit controls the combinational circuit so that the switching operations of the partial circuits are performed in an asynchronous manner according to temporal order and so that a switching operation is not performed in other partial circuits when a switching operation is performed in a partial circuit.

### CROSS REFERENCE TO RELATED APPLICATION

This application claims the benefit of Korean Patent Application No. 10-2012-0058247, filed on May 31, 2012, which is hereby incorporated by reference in its entirety into this application.

### BACKGROUND OF THE INVENTION

1. Technical Field

The present invention relates generally to an apparatus and method for reducing peak power using an asynchronous circuit design technology and, more particularly, to an apparatus and method that reduce peak power and average power by applying an asynchronous circuit design technology to a combinational circuit included in a digital circuit.

2. Description of the Related Art

As the degree of integration of a semiconductor chip becomes higher and clock speed becomes higher, the probability of an operating error attributable to a high on-chip electric field occurring on a semiconductor is increasing.

Accordingly, in the design of semiconductor chips, the reliability of operation has become an important issue. The effectiveness of a reduction in peak power has been recognized as a method of improving the reliability of a semiconductor chip. Here, the term “peak power” refers to the maximum power consumption during a cycle. In greater detail, the term “peak power” refers to the maximum of sums, each of which is the sum of power consumption during each unit time of a cycle.

Such peak power generates a hot electro effect and a high current flow, thereby deteriorating the reliability of a semiconductor chip. The hot electro effect causes a runaway current failure and a failure attributable to an electrostatic discharge, and the high current flow causes a voltage drop in the power distribution line of a semiconductor chip, thereby increasing average power and also making the supply of voltage to the semiconductor chip unstable.

In this connection, U.S. Patent Application Publication No. 2009-0288058 discloses an asynchronous circuit technology application that reduces average power. While the invention disclosed in the publication is intended to reduce average power via the conversion of a synchronous circuit into an asynchronous circuit, the present invention is intended to provide a method for reducing peak power by providing a circuit that plays an auxiliary role for an existing synchronous circuit.

### SUMMARY OF THE INVENTION

Accordingly, the present invention has been made keeping in mind the above problems occurring in the prior art, and an object of the present invention is to provide an apparatus and method for reducing peak power using an asynchronous circuit design technology, which are capable of individually controlling the switching operations of a combinational circuit according to temporal order by applying the asynchronous circuit design technology to the combinational circuit divided depending on the depth of the circuit, thereby preventing peak power from being increased by the overlapping of the switching operations in the combinational circuit.

In order to accomplish the above object, the present invention provides an apparatus for reducing peak power using an asynchronous circuit design technology, including a combinational circuit unit configured to divide a combinational circuit into a plurality of partial circuits based on depth of input and output; and an asynchronous control circuit unit configured to control the combinational circuit so that switching operations of the partial circuits are performed in an asynchronous manner according to temporal order and so that a switching operation is not performed in other partial circuits when a switching operation is performed in a partial circuit.

The combinational circuit unit may divide the combinational circuit into the plurality of partial circuits depending on the depth of input and output based on a gate level or register-transfer level netlist.

The combinational circuit unit may determine whether to divide the combinational circuit based on peak power, power consumption and overhead that may occur in a digital circuit.

The combinational circuit unit may determine the combinational circuit to be divided if the peak power and the power consumption exceed the overhead.

The asynchronous control circuit unit may set priorities according to the temporal order, and may control the switching operations of the partial circuits according to the set priorities.

The asynchronous control circuit unit may include an asynchronous circuit using an auxiliary clock that generates a sub cycle.

The asynchronous control circuit unit may include an asynchronous circuit using no clock.

The asynchronous control circuit unit may include a bather gate circuit unit and a delay element unit between the partial circuits.

The asynchronous control circuit unit may be connected to the bather gate circuit unit and the delay element unit, and control the switching operations of the partial circuits.

The delay element unit may adjust the time at which the bather gate circuit unit is activated based on the delay times of the partial circuits analyzed via static timing analysis.

In order to accomplish the above object, the present invention provides a method of reducing peak power using an asynchronous circuit design technology, including dividing, by a combinational circuit unit, a combinational circuit into a plurality of partial circuits based on depth of input and output; setting, by an asynchronous control circuit unit, switching operations of the partial circuits so that the switching operations are performed in an asynchronous manner according to temporal order; and controlling, by the asynchronous control circuit unit, the partial circuits so that a switching operation is not performed in other partial circuits when a switching operation has been performed in a partial circuit.

The dividing a combinational circuit into a plurality of partial circuits may include determining whether to divide the combinational circuit based on peak power, power consumption and overhead that may occur in a digital circuit.

The determining whether to divide the combinational circuit may include determining the combinational circuit to be divided if the peak power and the power consumption exceed the overhead.

The dividing a combinational circuit into a plurality of partial circuits may include dividing, by the combinational circuit unit, the combinational circuit unit into the plurality of partial circuits depending on the depth of input and output based on a gate level or register-transfer level netlist.

The asynchronous control circuit unit may include an asynchronous circuit using an auxiliary clock that generates a sub cycle.

The asynchronous control circuit unit may include an asynchronous circuit using no clock.

A bather gate circuit unit and a delay element unit may be provided between the partial circuits.

The asynchronous control circuit unit may be connected to the bather gate circuit unit and the delay element unit, and control the switching operations of the partial circuits.

The controlling the partial circuits may include adjusting, by the delay element unit, a time at which the bather gate circuit unit is activated depending on delay times of the partial circuits; and being, by the bather gate circuit, activated at the time at which the bather gate circuit unit is activated and preventing, by the bather gate circuit, a switching operation of a partial circuit from propagating to other partial circuits.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the concept of a combinational circuit;

FIG. 2 is a diagram illustrating the signals and power consumption patterns of the combinational circuit of FIG. 1;

FIGS. 3 and 4 are diagrams illustrating the schematic configurations of an apparatus for reducing peak power using an asynchronous circuit design technology according to an embodiment of the present invention;

FIG. 5 is a diagram illustrating the signal processing of the apparatus for reducing peak power using an asynchronous circuit design technology according to an embodiment of the present invention;

FIG. 6 is a diagram illustrating the data signal processing of the apparatus for reducing peak power using an asynchronous circuit design technology according to an embodiment of the present invention;

FIG. 7 is a diagram illustrating a method of constructing the apparatus for reducing peak power using an asynchronous circuit design technology according to an embodiment of the present invention; and

FIG. 8 is a diagram illustrating a method for reducing peak power using an asynchronous circuit design technology according to an embodiment of the present invention.

### DESCRIPTION OF THE PREFERRED EMBODIMENTS

Embodiments of the present invention will be described with reference to the accompanying drawings in order to fully describe the present invention so that persons having ordinary knowledge in the art can easily practice the technical spirit of the present invention. It should be noted that like reference symbols are used to designate like elements throughout the drawings even when the elements are illustrated in different drawings. Furthermore, in the following description of the present invention, detailed descriptions of one or more related well-known constructions and/or one or more functions which have been deemed to make the gist of the present invention unnecessarily vague will be omitted.

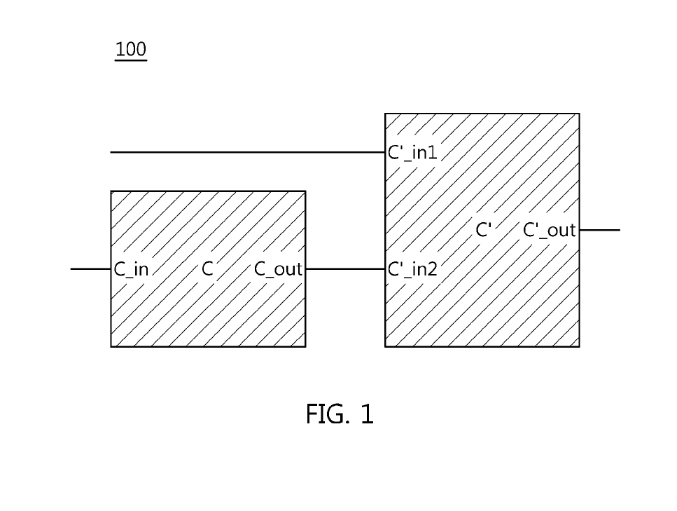

FIG. 1 is a diagram illustrating the concept of a combinational circuit

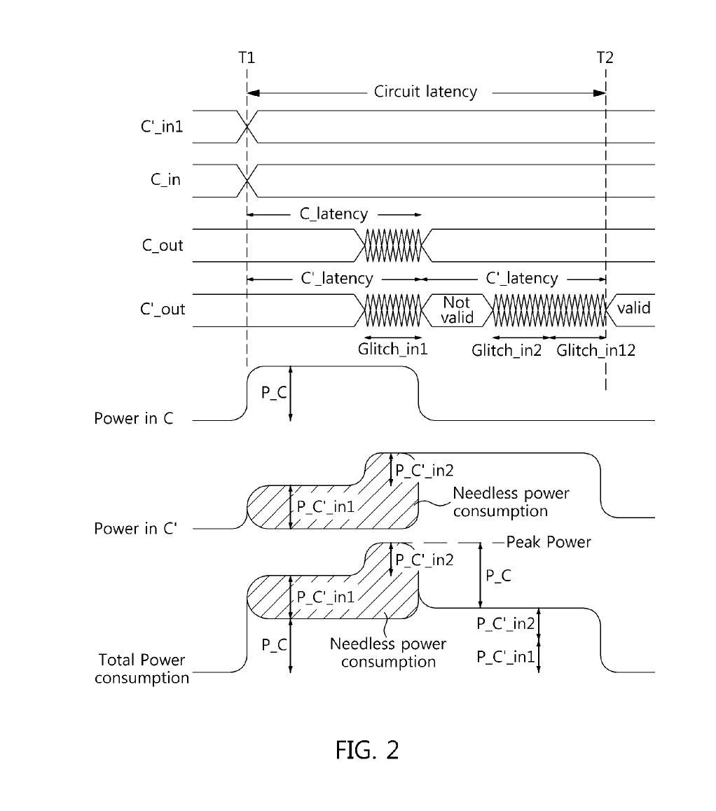

Referring to FIG. 1, a general digital circuit 100 includes combinational circuits C and C′, which receive inputs from the outside. The combinational circuit C′ includes two input ports, and receives an output value from the combinational circuit C via one of its two input ports. That is, the total output value of the digital circuit 100 may be considered to be valid in the delay time of the combinational circuit C′ after the stabilization of the output value of the combinational circuit C. However, in this case, power consumption is caused by unneeded switching in the combinational circuit C′. Two factors that cause unneeded switching are the transition of C′_in1 and a glitch from the combinational circuit C before the stabilization of the output of the combinational circuit C. A detailed description thereof will be given with reference to FIG. 2.

The signals and power consumption patterns of the combinational circuit of FIG. 1 will be described in detail with reference with FIG. 2.

Referring to FIG. 2, in the state in which inputs C′_in1 and C_in from the outside are given at the same time, a C′_out value becomes valid at time T2 after circuit latency C_latency, that is, the circuit delay time. Although C′ does not need to operate until C provides a stable output after C_latency, C′ consumes unneeded power because of the occurrence of switching in C′ attributable to glitches from C′_in1 and C, as shown in the drawing. In the temporal order, when C′_in1 propagates to C′, the power is consumed. The amount of power consumption is P_C′_in1 in the drawing. As the output of the next C is input to C′_in2, the power consumption is increased. The amount of power consumption is P_C′_in2. In this case, power consumption occurs because of a glitch occurring in C during a predetermined time (Glitch_in1). After that time, the power consumption corresponding to the sum of P_C′_in1 and P_C′_in2 continues until a stable output value is calculated. In the drawing, the hatched portions indicate the amounts of needless power consumption attributable to glitches from the outside and C. From the drawing that shows overall power consumption, it can be seen that the peak power as well as the overall power consumption is increased by needless power consumption. Accordingly, a method for reducing the consumption of unneeded peak power and average power is proposed in the present invention.

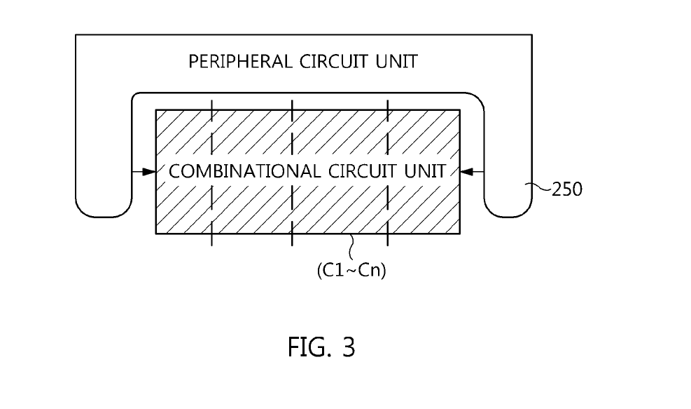

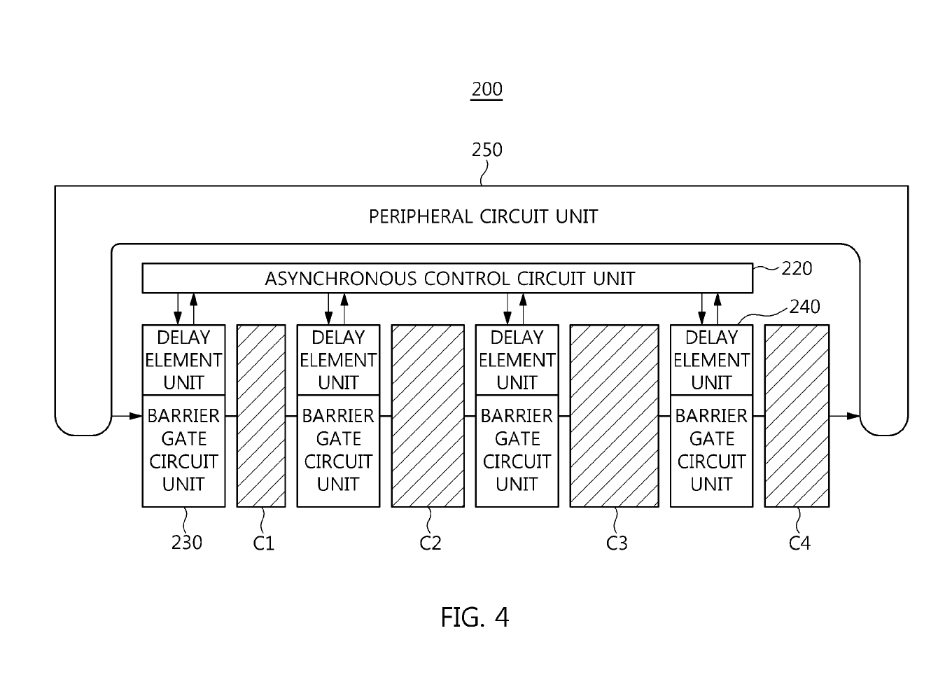

The configuration of an apparatus 200 for reducing peak power using an asynchronous circuit design technology according to an embodiment of the present invention will be described in detail with reference to FIGS. 3 and 4.

Referring to FIGS. 3 and 4, the apparatus 200 for reducing peak power using an asynchronous circuit design technology according to the present invention includes a combinational circuit unit (C1 to Cn) 100, an asynchronous control circuit unit 220, a bather gate circuit unit 230, a delay element unit 240, and a peripheral circuit unit 250.

A general combinational circuit unit is a logical circuit whose output value is determined only by input values at any point in time. That is, a general combinational circuit unit is a circuit that receives at least two input signals, logically operates with respect to the signals, and then generates an output signal. In this case, the combinational circuit unit is a functional unit, that is, a large scale combinational circuit, such as a multiplier. Although the idea of the present invention may be applied to design, the idea may be used to optimize a designed circuit.

The combinational circuit unit C1 to Cn is divided into a plurality of partial circuits C1, C2, C3 and C4 depending on the depth of input and output. In this case, the criteria for dividing the combinational circuit depending on the depth of input and output is based on a gate level or register-transfer level netlist. The scale is determined to be equal to or higher than a certain scale by taking into account the overhead of the asynchronous control circuit unit 220 in accordance with an algorithm proposed in the present invention.

The asynchronous control circuit unit 220 is set such that the switching of the partial circuits is performed in an asynchronously manner according to temporal order. While synchronous control has the restriction in which the delay times of the input and output of the combinational circuits should be uniform, asynchronous control may set and control a different delay time for each combinational circuit. The present invention adopts the asynchronous control technology.

The asynchronous control circuit unit 220 performs control so that switching is not performed in the other partial circuits when switching has been performed in a partial unit circuit according to temporal order. That is, the partial circuits are prioritized according to temporal order by the asynchronous control circuit unit 220, and switching may be controlled according to the set priorities with a time difference set therebetween.

However, although the above partial circuits are controlled according to the temporal order, the peak power can be reduced only when switching occurring in a partial circuit should be prevented from propagating to other partial circuits. The reason for this is that a glitch, that is, unneeded switching, may occur in other partial circuits because of switching occurring in a partial circuit.

Accordingly, in the present invention, the bather gate circuit unit 230 and the delay element unit 240 are further included in order to prevent switching from propagating to other partial circuits, and are connected to the asynchronous control circuit unit 220.

The bather gate circuit unit 230 is provided between the partial circuits, and prevents switching from propagating from one partial circuit to other partial circuits. That is, the bather gate circuit unit 230 may further include a three-phase buffer or a bus keeper (not shown) so that a partial circuit can internally maintain a previous value so as to prevent the transmission of output from other partial circuits until the partial circuit is activated by the asynchronous control circuit unit 220.

The delay element unit 240 is provided between the partial circuits, more specifically on one side of the bather gate circuit unit 230, and controls the time at which the barrier gate circuit unit 230 is activated depending on the delay time of the partial circuits. Here, it is preferable to analyze the delay time based on static timing analysis. Here, the static timing analysis is not a method of applying test input in a specific form, but is an analysis method of searching for a path that may exhibit an unstable operation while taking into account all signal transmission paths existing between the memory elements of a circuit.

The peripheral circuit unit 250 is an area that covers the combinational circuit unit C1 to Cn, and includes a peripheral circuit that controls the data input and output of the digital circuit.

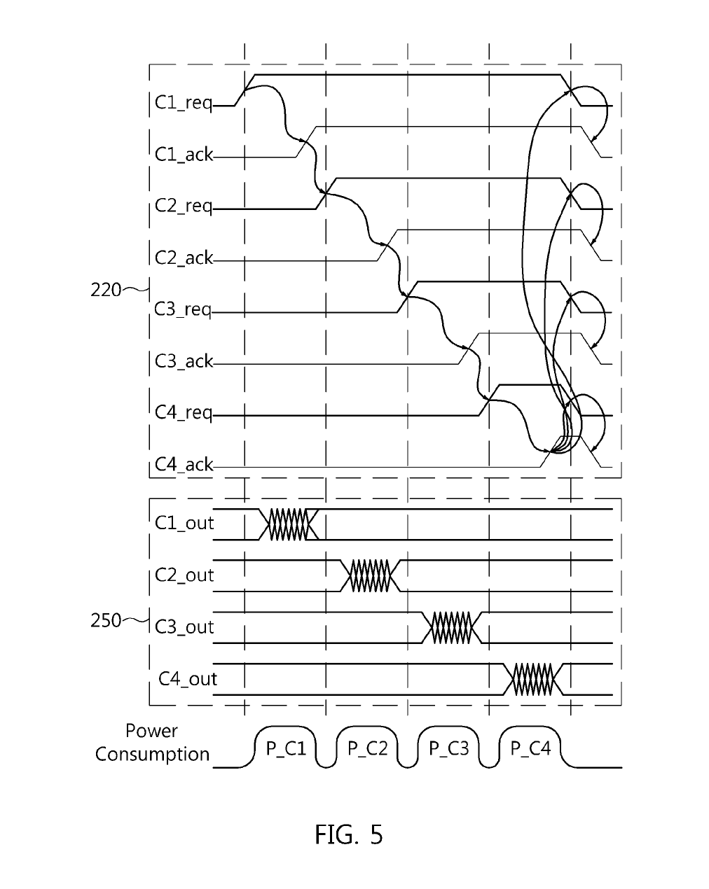

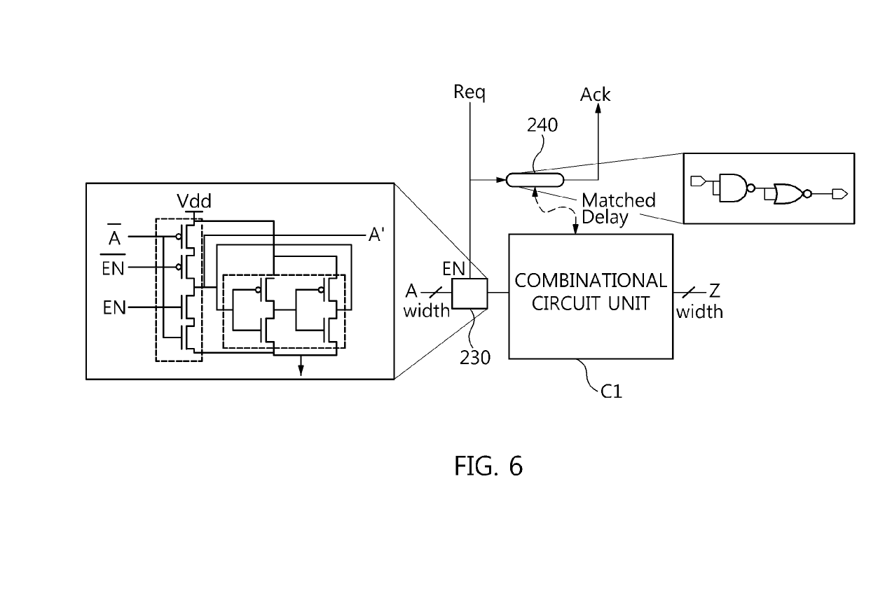

The data signal processing of the apparatus for reducing peak power using an asynchronous circuit design technology according to the embodiment of the present invention will be described in detail with reference to FIGS. 5 and 6.

Referring to FIG. 5, the partial circuits are controlled at time differences by the asynchronous control circuit unit 220 that has been designed in an asynchronous manner. Each req signal (e.g., C1_req) is connected to the EN of the bather and the delay element unit 240. For example, the C1_req signal is converted into a C1_ack signal via the delay element unit 240. A controller which has received an ack signal causes C2_req to rise. If, in this order, C4_req rises to 1 and C4_ack rises to 1, all reqs are caused to fall. The reason why req, i.e., EN, is maintained at 1 is to stabilize capacitance until the output of the sequential circuit of the final stage is completed. After the output has been completed, the switching of the combinational circuit is reduced, so that there is no problem even when a weak operation is performed using the three-phase buffer or bus keeper in the bather gate circuit unit 230.

Meanwhile, referring to FIG. 6, when the EN signal becomes 1 in the state in which a data signal A has been input via the peripheral circuit unit 250, value A is transferred to output A′. When the EN value becomes 0, the output of the bather gate circuit unit 230 becomes floating in the drawing, and then the weak signal stored in the three-phase buffer or the bus keeper is applied to output A′. Accordingly, it is assumed that the input of the partial circuit is converted by an external clock and its input value is maintained until an output value for the input is output from the partial circuit.

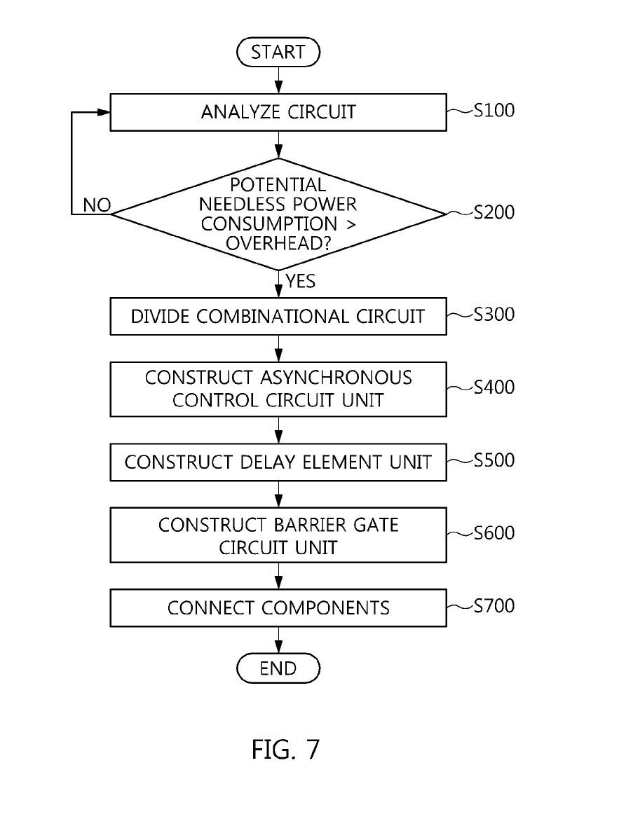

A method of constructing the apparatus for reducing peak power using an asynchronous circuit design technology according to an embodiment of the present invention will be described in detail with reference to FIG. 7.

Referring to FIG. 7, in the method of constructing an apparatus for reducing peak power using an asynchronous circuit design technology according to the embodiment of the present invention, first, it will be determined whether to divide a combinational circuit based on peak power, power consumption and overhead that may be generated in a digital circuit at steps S100 and S200.

At step S200, if potential needless power consumption(the peak power and the power consumption) exceed the overhead, a combinational circuit included in a digital circuit is divided into a plurality of partial circuits depending on the depth of input and output. In this case, the combinational circuit may be divided into a plurality of partial circuits depending on the depth of input and output based on a gate level or register-transfer level netlist.

Thereafter, the asynchronous control circuit unit 220 is configured such that the switching of the partial circuits is performed in an asynchronous manner according to temporal order at step S400. Here, the asynchronous control circuit unit 220 may be formed of either an asynchronous circuit using an auxiliary clock for generating a sub cycle or an asynchronous circuit using no clock.

Thereafter, the delay element units 240 suitable for the partial circuits are disposed between the partial circuits bases on static timing analysis at step S500.

Thereafter, the bather gate circuits 230 are disposed between the partial circuits, that is, on the first sides of the delay element units 240 at step S600.

Finally, the barrier gate circuits 230 disposed at step S600 are connected to the delay element units 240 and the asynchronous control circuit unit 220 at step 700, so that the switching of the partial circuits can be controlled by the asynchronous control circuit unit 220.

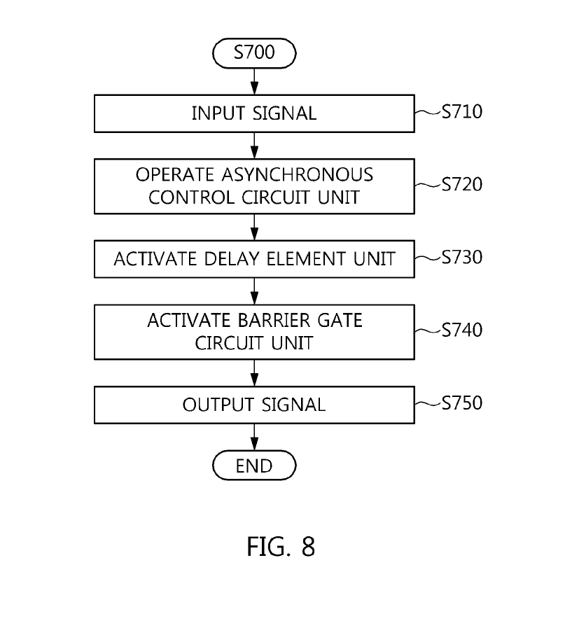

A method for reducing peak power using an asynchronous circuit design technology according to the embodiment of the present invention will be described in detail with reference to FIG. 8.

Referring to FIG. 8, in the method for reducing peak power using an asynchronous circuit design technology according to the embodiment of the present invention, first, when a data signal is input to the combinational circuit unit C1 to Cn divided into a plurality of partial circuits by the peripheral circuit 250, the asynchronous control circuit unit 220 performs a control operation at steps S710 and S720. In this case, the asynchronous control circuit unit 220 controls the partial circuits so that switching is performed in an asynchronous manner according to temporal order and so that switching is not performed in the other partial circuits when switching has been performed in one partial circuit.

Thereafter, the asynchronous control circuit unit 220 activates the delay element units 240 in response to the delay time of the partial circuit, thereby adjusting the time at which the bather gate circuit units 230 are activated using the delay element units 240 at step S730.

Thereafter, as the bather gate circuits 230 are activated in response to the time at which the delay element units 240 are activated, the asynchronous control circuit unit 220 can prevent switching from propagating from one partial circuit to other partial circuits at step S740.

As described above, the apparatus and method for reducing peak power using an asynchronous circuit design technology according to the present invention has the advantage of preventing peak power from being increased by the overlapping of the switching operations in the combinational circuit because the apparatus and method individually control the switching operations of a combinational circuit according to temporal order by applying the asynchronous circuit design technology to the combinational circuit divided depending on the depth of the circuit.

As a result, the apparatus and method have the advantage of ensuring reliability by preventing the erroneous operation of the circuit because they reduce peak power and average power using an asynchronous circuit design technology.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for reducing peak power using an asynchronous circuit design technology, comprising:
a combinational circuit unit configured to divide a combinational circuit into a plurality of partial circuits based on depth of input and output; and
an asynchronous control circuit unit configured to control the combinational circuit so that switching operations of the partial circuits are performed in an asynchronous manner according to temporal order and so that a switching operation is not performed in other partial circuits when a switching operation is performed in a partial circuit.

2. The apparatus of claim 1, wherein the combinational circuit unit divides the combinational circuit into the plurality of partial circuits depending on the depth of input and output based on a gate level or register-transfer level netlist.

3. The apparatus of claim 1, wherein the combinational circuit unit determines whether to divide the combinational circuit based on peak power, power consumption and overhead that may occur in a digital circuit.

4. The apparatus of claim 3, wherein the combinational circuit unit determines the combinational circuit to be divided if the peak power and the power consumption exceed the overhead.

5. The apparatus of claim 1, wherein the asynchronous control circuit unit sets priorities according to the temporal order, and controls the switching operations of the partial circuits according to the set priorities.

6. The apparatus of claim 1, wherein the asynchronous control circuit unit comprises an asynchronous circuit using an auxiliary clock that generates a sub cycle.

7. The apparatus of claim 1, wherein the asynchronous control circuit unit comprises an asynchronous circuit using no clock.

8. The apparatus of claim 1, wherein the asynchronous control circuit unit comprises a bather gate circuit unit and a delay element unit between the partial circuits.

9. The apparatus of claim 8, wherein the asynchronous control circuit unit is connected to the barrier gate circuit unit and the delay element unit, and controls the switching operations of the partial circuits.

10. The apparatus of claim 8, wherein the delay element unit adjusts a time at which the bather gate circuit unit is activated based on delay times of the partial circuits analyzed via static timing analysis.

11. A method of reducing peak power using an asynchronous circuit design technology, comprising:
dividing, by a combinational circuit unit, a combinational circuit into a plurality of partial circuits based on depth of input and output;
setting, by an asynchronous control circuit unit, switching operations of the partial circuits so that the switching operations are performed in an asynchronous manner according to temporal order; and
controlling, by the asynchronous control circuit unit, the partial circuits so that a switching operation is not performed in other partial circuits when a switching operation has been performed in a partial circuit.

12. The method of claim 11, wherein the dividing a combinational circuit into a plurality of partial circuits comprises determining whether to divide the combinational circuit based on peak power, power consumption and overhead that may occur in a digital circuit.

13. The method of claim 12, wherein the determining whether to divide the combinational circuit comprises determining the combinational circuit to be divided if the peak power and the power consumption exceed the overhead.

14. The method of claim 11, wherein the dividing a combinational circuit into a plurality of partial circuits comprises dividing, by the combinational circuit unit, the combinational circuit unit into the plurality of partial circuits depending on the depth of input and output based on a gate level or register-transfer level netlist.

15. The method of claim 11, wherein the asynchronous control circuit unit comprises an asynchronous circuit using an auxiliary clock that generates a sub cycle.

16. The method of claim 11, wherein the asynchronous control circuit unit comprises an asynchronous circuit using no clock.

17. The method of claim 11, wherein a bather gate circuit unit and a delay element unit are provided between the partial circuits.

18. The method of claim 17, wherein the asynchronous control circuit unit is connected to the barrier gate circuit unit and the delay element unit, and controls the switching operations of the partial circuits.

19. The method of claim 18, wherein the controlling the partial circuits comprises:
adjusting, by the delay element unit, a time at which the bather gate circuit unit is activated depending on delay times of the partial circuits; and
being, by the bather gate circuit, activated at the time at which the barrier gate circuit unit is activated and preventing, by the bather gate circuit, a switching operation of a partial circuit from propagating to other partial circuits.
